(19) United States
(12) Patent Application Publication
(10) Pub. No.: US 2003/0154211 A1
(43) Pub. Date: Aug. 14, 2003

(54) Methods of gathering and delivering information, terminal unit and server for information processing, and computer product

(75) Inventor: Tomomi Kasahara, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/200,513

(22) Filed: Jul. 23, 2002

(30) Foreign Application Priority Data
Feb. 14, 2002 (JP) 2002-037350

(51) Int. Cl. G06F 7/00

(52) U.S. Cl. 707/102

(57) ABSTRACT

An inquiry information reception section receives an inquiry relating to a certain area from a sender, an object device extraction section extracts information processing terminals present in that area, an inquiry information transmission unit transmits the inquiry to the information processing terminals. A response information reception unit receives a response corresponding to the inquiry from the information processing terminals, and a response information transmission unit transmits the response as it is or after processing to the sender.

### FIELD OF THE INVENTION

This invention relates to methods of gathering and delivering information, a terminal unit and a server used for information processing, and computer programs and computer-readable recording medium.

### BACKGROUND OF THE INVENTION

The information of an area away from the present place may be required timely. Such information includes, for example, the traffic information and the weather information. Such information is generally obtained from the broadcasting media such as the radio and the television in the form of media information.

However, the media information has a problem relating to the credibility of the information contents depending on the freshness of information and the method of gathering information, and frequently, the information of an area away from the present place may not be obtained timely. In order to increase the freshness of information, there is a problem in that enormous investment in plant and equipment such as monitoring cameras and various sensors are required. Further, in many instances, these media provide general information focusing on unspecified majority, and hence it is difficult to provide information requested from each individual thereto.

With the popularization of the portable information processing terminal units, such as the mobile phone, many people carry the portable information processing terminal unit, and communicate with each other. In the information gathering between individuals by using a portable information processing terminal unit, it is effective only when it is known that a friend is in a predetermined area. If there is no friend, or even if there is a friend but the friend is not in the desired area, effective information cannot be gathered. As described above, there are many persons having information of each area and an information processing terminal unit that can transmit this information, but in the conventional communication between individuals, since it is difficult to connect these persons, there is a problem in that it cannot function sufficiently as a tool to gather information of areas away from the present place.

### SUMMARY OF THE INVENTION

It is an object of this invention to provide a technology which makes it possible to easily and reliably gather and provide area information having immediacy.

The information gathering method according to one aspect of the present invention comprises an object device extraction step of extracting all or a part of information processing terminal units which are present in a predetermined area, an inquiry information transmission step of transmitting inquiry information relating to the predetermined area to the extracted information processing terminal unit(s), a response information reception step of receiving response information obtained in response to the transmitted inquiry information from the extracted information processing terminal units, and a database creation step of creating a database of the response information corresponding to the predetermined area.

The information delivering method according to another aspect of the present invention comprises an inquiry information reception step of receiving inquiry information relating to a predetermined area, an object device extraction step of extracting all or a part of information processing terminal units which are present in the predetermined area, an inquiry information transmission step of transmitting inquiry information to the extracted information processing terminal units, a response information reception step of receiving response information obtained in response to the transmitted inquiry information from the extracted information processing terminal units, and a response information transmission step of transmitting the received response information as it is or edit information obtained by editing the response information to the sender of the inquiry information.

The computer programs according to still another aspect of the present invention include instruction that make a computer execute the methods according to present invention on the computer. The computer-readable recording medium according to still another aspect of the present invention stores the computer programs according to present invention.

The information processing server according to still another aspect of the present invention comprises an object device extraction unit which extracts all or a part of information processing terminal units which are present in a predetermined area, an inquiry information transmission unit which transmits inquiry information relating to the predetermined area to the extracted information processing terminal unit(s), a response information reception unit which receives response information obtained in response to the transmitted inquiry information from the extracted information processing terminal units, and a database creation unit which creates a database of the response information corresponding to the predetermined area.

The information processing server according to still another aspect of the present invention comprises an inquiry information reception unit which receives inquiry information relating to a predetermined area, an object device extraction unit which extracts all or a part of information processing terminal units which are present in the predetermined area, an inquiry information transmission unit which transmits inquiry information to the extracted information processing terminal units, a response information reception unit which receives response information obtained in response to the transmitted inquiry information from the extracted information processing terminal units, and a response information transmission unit which transmits the received response information as it is or edit information obtained by editing the response information to the sender of the inquiry information.

The information processing terminal unit according to still another aspect of the present invention comprises an inquiry information reception unit which receives inquiry information relating to a predetermined area from an information processing server, an inquiry information output unit which outputs the received inquiry information, a response information input unit inputting response information corresponding to the received inquiry information, and a response information transmission unit which transmits the response information to the information processing server.

The information processing terminal unit according to still another aspect of the present invention comprises an inquiry information input unit for inputting inquiry information relating to a predetermined area, an inquiry information transmission unit which transmits the input inquiry information to an information processing server, a response information reception unit which receives response information corresponding to the transmitted inquiry information, and a response information output unit which outputs the received response information.

Other objects and features of this invention will become apparent from the following description with reference to the accompanying drawings.

### BRIEF DESCRIPTION OF THE DRAWINGS

FIG. 1 shows the summary of an embodiment of this invention,

FIG. 2 shows the data construction of a reception master in an information processing server according to the embodiment of this invention,

FIG. 3 shows the data construction of an inquiry master in the information processing server according to the embodiment of this invention,

FIG. 4 shows the data construction of a result master in the information processing server according to the embodiment of this invention,

FIG. 5 shows the data construction of a member master in the information processing server according to the embodiment of this invention,

FIG. 6 shows the data construction of a response master in the information processing server according to the embodiment of this invention,

FIG. 7 is a block diagram which shows one example of the hardware configuration of the information processing server according to the embodiment of this invention,

FIG. 8 is a block diagram which shows one example of the hardware configuration of an information processing terminal unit according to the embodiment of this invention,

FIG. 9 is a block diagram which shows a functional configuration of the information processing server according to the embodiment of this invention,

FIG. 10 is a block diagram which shows a functional configuration of the information processing terminal unit according to the embodiment of this invention,

FIG. 11 is a block diagram which shows a functional configuration of another information processing terminal unit according to the embodiment of this invention,

FIG. 12 is a flowchart which shows a processing procedure of the information processing server according to the embodiment of this invention,

FIG. 13 is a flowchart which shows another processing procedure of the information processing server according to the embodiment of this invention,

FIG. 14 is a flowchart which shows another processing procedure of the information processing server according to the embodiment of this invention,

FIG. 15 is a flowchart which shows a processing procedure of the information processing terminal unit according to the embodiment of this invention,

FIG. 16 shows one example of display contents of a display in the information processing terminal unit according to the embodiment of this invention,

FIG. 17 is a flowchart which shows another processing procedure of the information processing terminal unit according to the embodiment of this invention,

FIG. 18 shows another example of display contents of the display in the information processing terminal unit according to the embodiment of this invention,

FIG. 19 is a flowchart which shows another processing procedure of the information processing terminal unit according to the embodiment of this invention,

FIG. 20 shows another example of display contents of the display in the information processing terminal unit according to the embodiment of this invention,

FIG. 21 shows another example of display contents of the display in the information processing terminal unit according to the embodiment of this invention,

FIG. 22 is a flowchart which shows another processing procedure of the information processing terminal unit according to the embodiment of this invention,

FIG. 23 shows another example of display contents of the display in the information processing terminal unit according to the embodiment of this invention,

FIG. 24 shows another example of display contents of the display in the information processing terminal unit according to the embodiment of this invention,

FIG. 25 shows another example of display contents of the display in the information processing terminal unit according to the embodiment of this invention,

FIG. 26 shows another example of display contents of the display in the information processing terminal unit according to the embodiment of this invention,

FIG. 27 shows another example of display contents of the display in the information processing terminal unit according to the embodiment of this invention.

### DETAILED DESCRIPTIONS

Embodiments of the methods of gathering and delivering information, the terminal unit and the server for information processing, and the computer programs and the computer-readable recording medium according to this invention will be explained in detail, with reference to the accompanying drawings.

Summary of the embodiment

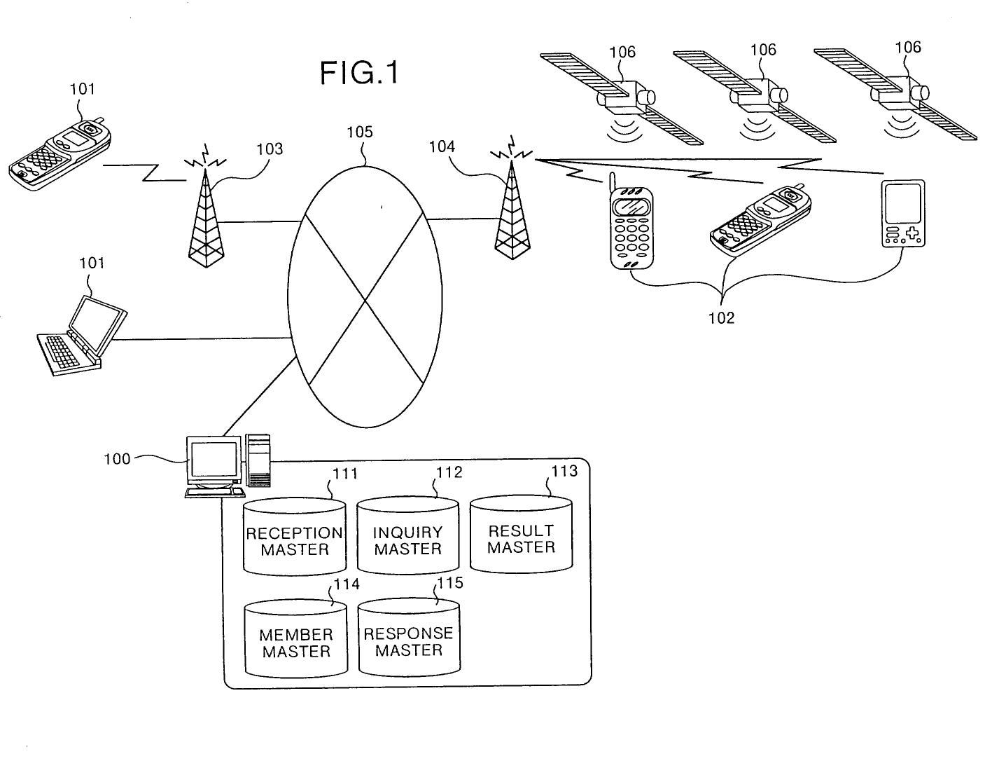

The summary of the embodiment of this invention will be first explained. FIG. 1 shows the summary of the embodiment of this invention. In FIG. 1, reference symbol 100 denotes an information processing server, 101 denotes an information processing terminal unit which is used for inputting inquiry information, 102 denotes an information processing terminal unit which is used for inputting response information, 103 and 104 denote a radio base station, 105 denotes network such as the Internet and a telephone line, and 106 denotes a satellite (a plurality of U.S. GPS satellites). The information processing server 100 has a reception master 111, an inquiry master 112, a result master 113, a member master 114, and a response master 115.

The information processing terminal unit 101 is used for inputting information relating to a predetermined area which is desired to obtain, for example, traffic jam information or information relating to weather, as inquiry information. As one example, it is assumed herein that the inquiry information is “traffic jam condition in point A”. The information processing terminal unit 101 transmits the input inquiry information to the information processing server 100 via the network 105 connected to the information processing terminal unit 101. When the information processing terminal unit 101 is a mobile phone or the like, it is connected to the network 105 via the radio base station 103.

The information processing server 100 receives the inquiry information relating to the predetermined area, that is, the “traffic jam condition in point A”, from the information processing terminal unit 101. The information processing server 100 extracts the predetermined area information, that is, “point A” from the contents of the received inquiry information, and specifies one or a plurality of information processing terminal units 102 existing in this area. Specifying the information processing terminal unit 102 can be done based on the position information measured using the GPS, or the position information obtained by the radio base station 104 which performs radio-wave transmission/reception with the information processing terminal unit 102.

The information processing server 100 transmits the inquiry information, that is, the “traffic jam condition” to the information processing terminal unit 102 which is specified to exist in “point A” via the network 105 and the radio base station 104. A person, who carries the information processing terminal unit 102 which has received the inquiry information, inputs, as the response information with respect to the inquiry, “traffic jam information=being jammed”, which can be known at the current position, that is, at “point A”. The information processing terminal unit 102 then transmits the input response information to the information processing server 100 via the network 105, using a reply function or the like.

The information processing server 100 receives the response information, that is, information of “being jammed”, from the information processing terminal unit 102 via the network 105, and transmits the received response information to the information processing terminal unit 101 that has transmitted the inquiry information (“being jammed”). At this time, when having received a plurality of response information, the information processing server 100 may edit the plurality of response information and transmit the edited information. In this manner, the information processing terminal unit 101 can obtain information relating to the predetermined area, that is, “traffic jam condition at point A=being jammed”. At this time, it is not necessary to know the existence of the person who carries the information processing terminal unit 102 existing in point A, and who is the person carrying the terminal unit. Therefore, it becomes possible to easily obtain desired information, utilizing many and unspecified information providers.

Data Construction of Each Master:

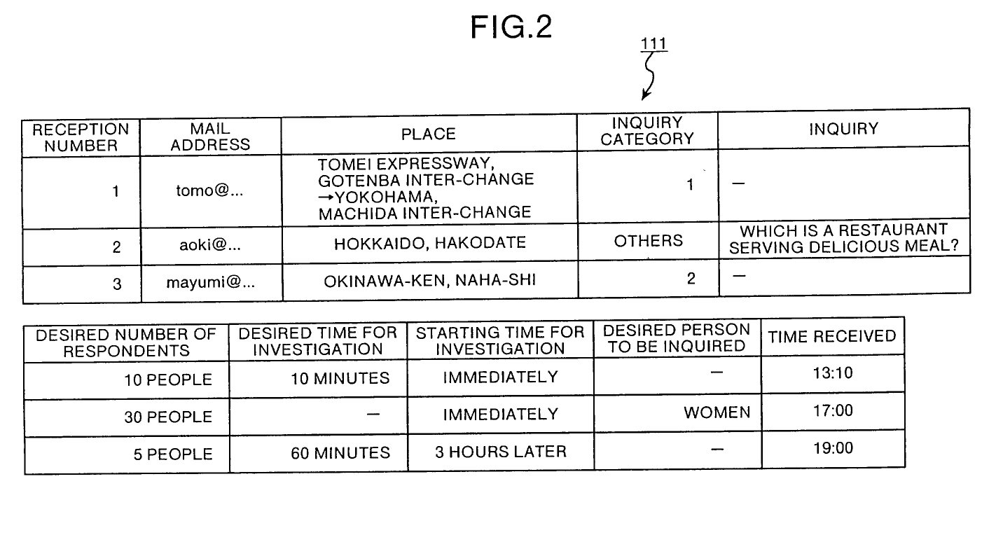

Each data construction of the reception master 111, the inquiry master 112, the result master 113, the member master 114, and the response master 115 which are included in the information processing server 100 will now be explained. FIG. 2 shows the data construction of the reception master 111 in the information processing server 100. The reception master 111 is for registering the reception information received by the information processing server 100.

In FIG. 2, the reception master 111 comprises “reception number”, “mail address” of the information processing terminal unit 101 that has transmitted the inquiry information, “place”, that is, the area information showing the area relating to the inquiry information, “inquiry category” for classifying the inquiry contents, “inquiry”, that is, specific question when the inquiry category is “others”, “desired number of respondents”, “desired time for investigation”, “starting time for investigation”, “desired person to be inquired” and “time received”.

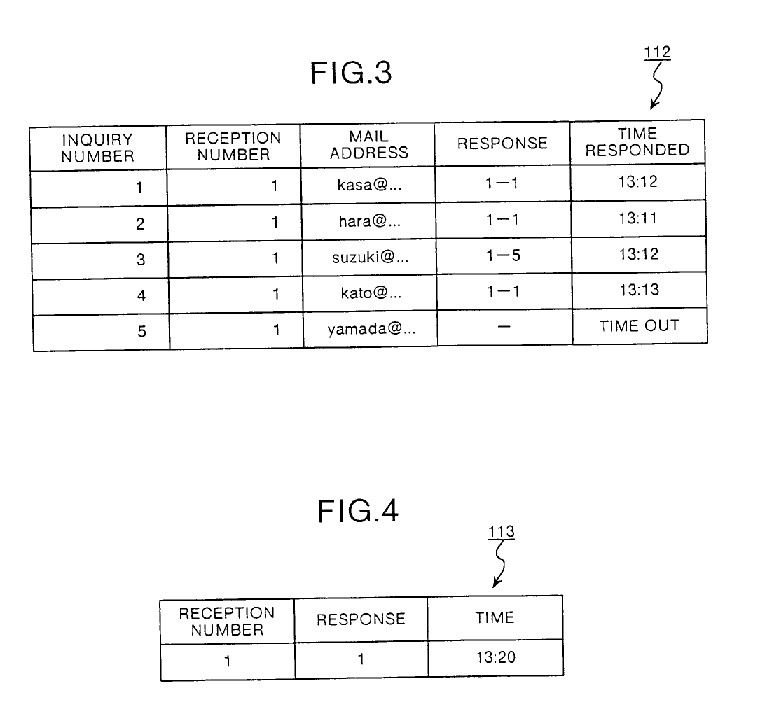

FIG. 3 shows the data construction of the inquiry master 112 in the information processing server 100. The inquiry master 112 is for registering the information regarding the information processing terminal unit 102 that has submitted the inquiry information. In FIG. 3, the inquiry master 112 comprises “inquiry number”, “reception number” in the reception master 111, “mail address” of the information processing terminal unit 102 to be inquired, “response”, that is the response information from the origin of the inquiry, and “time responded”.

FIG. 4 shows the data construction of the result master 113 in the information processing server 100. The result master 113 is for registering the contents of the response information with respect to the inquiry information to be transmitted to the information processing terminal unit 101 which has transmitted the inquiry. In FIG. 4, the result master 113 comprises “reception number” in the reception master 111, “response”, that is, the response information to be transmitted to the information processing terminal unit 101 which has transmitted the inquiry, and the “time” at which the response information is transmitted to the information processing terminal unit 101 which has transmitted the inquiry.

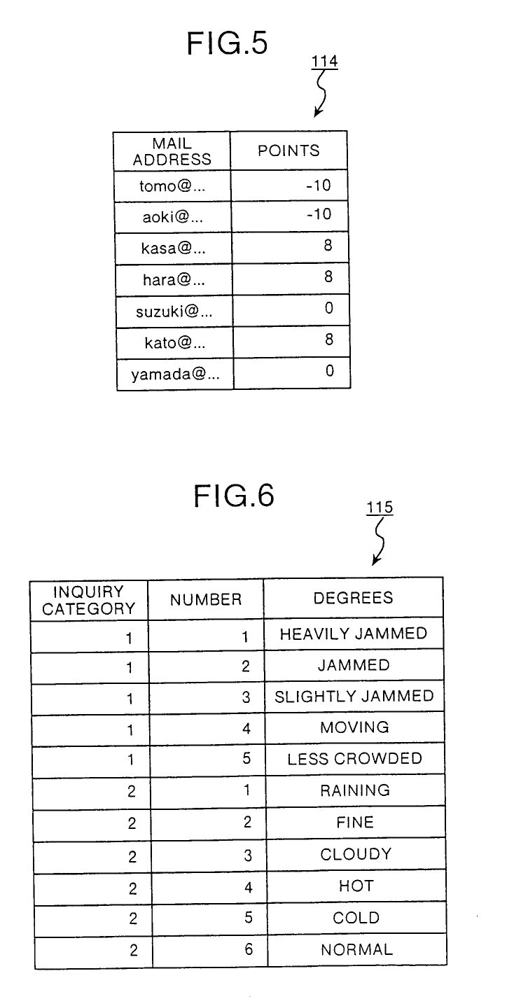

FIG. 5 shows the data construction of the member master 114 in the information processing server 100. The member master 114 is for registering the information relating to the person carrying the information processing terminal unit 101 or 102, who is a member. In FIG. 5, the member master 114 comprises “mail address” of the person carrying the information processing terminal unit 101 or 102, who is a member, and “points” increased or decreased when the information delivery service according to the embodiment of the present invention is used. Detailed contents of the “points” will be described later.

FIG. 6 shows the data construction of the response master 115 in the information processing server 100. The response master 115 is for registering the types of response with respect to the inquiry contents, prepared in advance. In FIG. 6, the response master 115 comprises “inquiry category” in the reception master 111, response “number” for each inquiry category, and “degrees”, that is, types of response with respect to the inquiry. The reason why the response master 115 is prepared is to improve the response by facilitating responses to mails and facilitating summing up the response results. Therefore, the response master 115 may not be provided, and the received e-mails may be read out and responses by speech may be transmitted directly with respect to the contents thereof.

Hardware Configuration of the Information Processing Server:

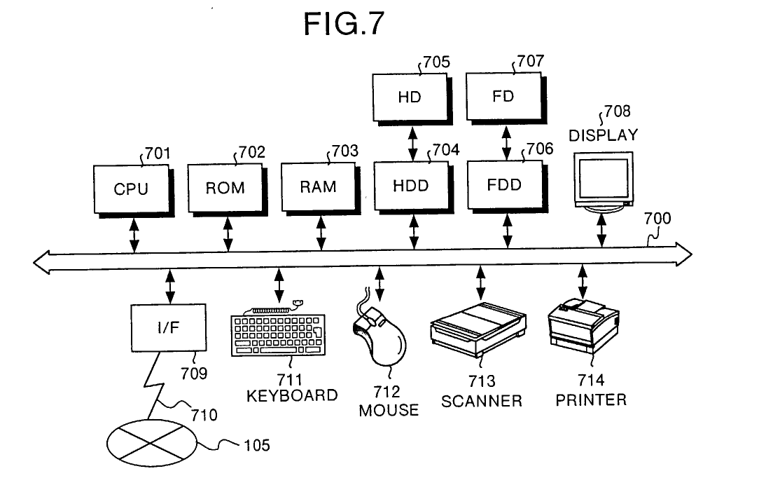

A hardware configuration of the information processing server 100 according to the embodiment of this invention will now be explained. FIG. 7 is a block diagram which shows one example of the hardware configuration of the information processing server 100 according to the embodiment of this invention.

In FIG. 7, the information processing server 100 comprises a CPU 701, a ROM 702, a RAM 703, a HDD (hard disk drive) 704, an HD (hard disk) 705, an FDD (flexible disk drive) 706, an FD (flexible disk) 707 as one example of a detachable recording medium, a display 708, an I/F (interface) 709, a keyboard 711, a mouse 712, a scanner 713, and a printer 714. Each component is connected with each other through a bus 700.

The CPU 701 takes charge of the whole control of the information processing server 100. The ROM 702 stores programs such as a boot program. The RAM 703 is used as a work area of the CPU 701. The HDD 704 controls read and write of data with respect to the HD 705, under control of the CPU 701. The HD 705 stores the written data under control of the HDD 704.

The FDD 706 controls read and write of data with respect to the FD 707, under control of the CPU 701. The FD 707 stores the written data under control of the FDD 706, or allows the data stored in the FD 707 to be read out by the information processing unit. The detachable recording medium may include a CD-ROM (CD-R, CD-RW), MO, DVD (Digital Versatile Disk), and a memory card, other than the FD 707.

The display 708 displays a cursor, an icon and a toolbox, as well as a window (browser) relating to data such as documents, images or function information. For example, the display 708 may be a CRT, a TFT liquid crystal display or a plasma display.

The I/F (interface) 709 is connected to the network 105 such as LAN or the Internet through a communication line 710, and connected to other servers and information processing unit via the network 105. The I/F 709 takes charge of the interface between the network 105 and the inside, so as to control input/output of data from other servers and information terminal unit. The I/F 709 is for example a modem.

The keyboard 711 comprises keys which input characters, figures and various instructions, to thereby input data. It may be a touch-panel type input pad or a ten key. The mouse 712 performs shift or area selection of a cursor, or shift or size change of a window. If it has the same function as a pointing device, it may be a track ball, a joystick, a cross key or a jog dial.

The scanner 713 reads out images optically, and takes the image data into the information processing unit. The printer 714 prints out the image data and document data. For example, it is a laser printer, an ink jet printer, or the like.

Hardware configuration of the information processing terminal unit:

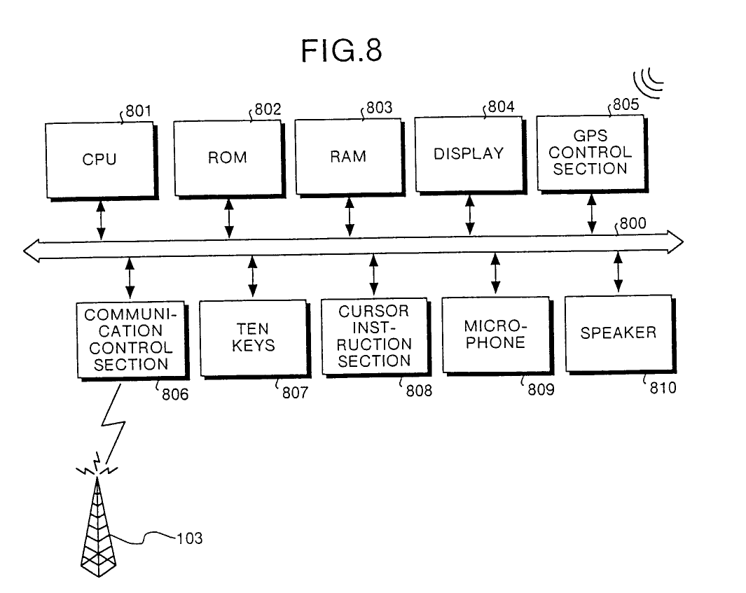

Hardware configuration of the information processing terminal units 101 and 102 according to the embodiment of this invention will be explained. FIG. 8 is a block diagram which shows one example of the hardware configuration of the information processing terminal units 101 and 102 according to the embodiment of this invention.

In FIG. 8, a mobile phone as one example of the information processing terminal units 101 and 102 comprises a CPU 801, a ROM 802, a RAM 803, a display 804, a GPS control section 805, a communication control section 806, a ten key 807, a cursor instruction section 808, a microphone 809 and a speaker 810. Each component is connected with each other via a bus 800.

The CPU 801 takes charge of the whole control of the information processing terminal units 101 and 102. The ROM 802 stores programs such as a boot program. The RAM 803 is used as a work area of the CPU 801. The display 804 displays data such as a cursor, an icon and a toolbox, as well as data such as documents, images and function information. For example, the display 904 may be a TFT liquid crystal display.

The GPS control section 805 receives radio waves from the GPS satellite 106, to thereby determine the geometrical position from the GPS satellite 106, which can be measured from anywhere on the earth. As the radio waves, there can be used a carrier wave of 1.575.42 MHz, being an Li radio wave on which a C/A (Coarse and Access) code and a navigation message are carried. The C/A code has a bit rate of 1.023 Mbps, and the length of the code is 1023 bit=1 ms. The navigation message has a bit rate of 50 bps, and the length of the code is such that the sub frame has the code length of 300 bit=6 s, and the main frame has the code length of 1500 bit=30 s, wherein 5 sub frames form one main frame, and 25 main frames form 1 master frame.

The communication control section 806 controls transmitting/receiving of radio waves with the radio base station 103, and is connected to the network 105, and is also connected to the information processing server 100 via the network 105. The communication control section 806 takes charge of the interface between the network 105 and the inside, to control input and output of data with other information processing servers 100.

The ten key 807 comprises keys which input characters, figures and various instructions, to input data. The cursor instruction section 808 performs shift or area selection of the cursor. If it has the same function as the pointing device, it may be a cross key or a jog dial. The microphone 809 inputs data by converting voice to an electric signal. The speaker 810 outputs voice. Both of the microphone 809 and the speaker 810 have a function as a telephone.

Functional Configuration of the Information Processing Server:

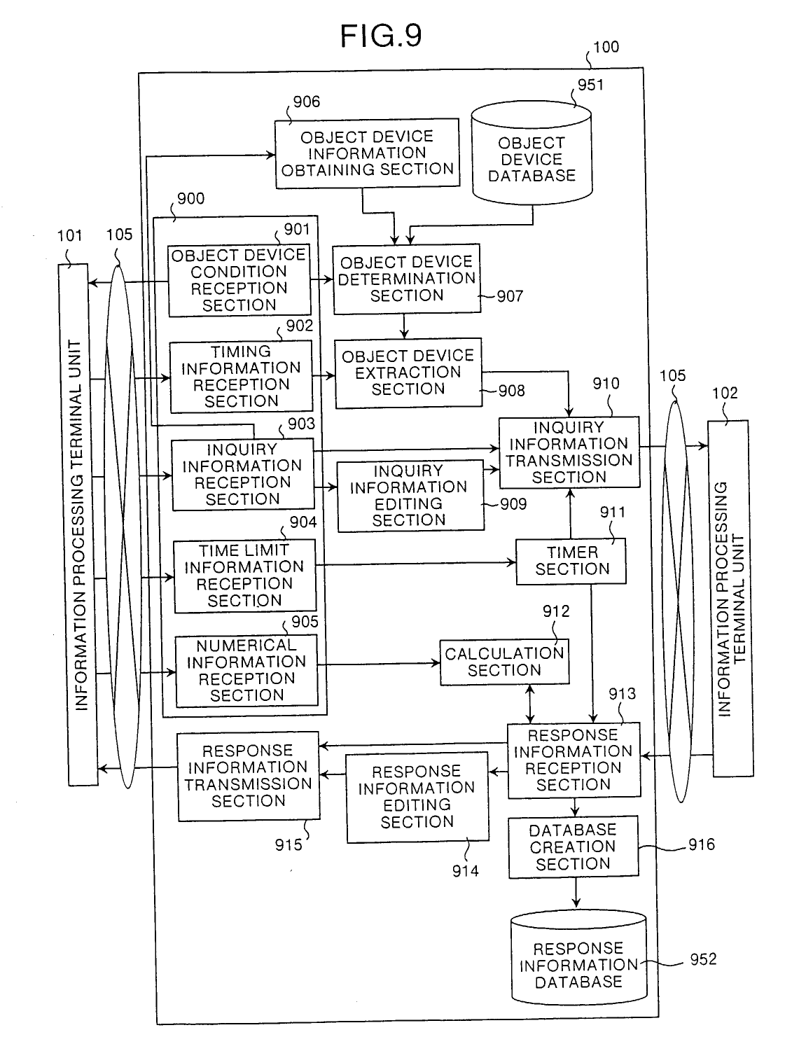

The functional configuration of the information processing server according to the embodiment of this invention will now be explained. FIG. 9 is a block diagram which shows the functional configuration of the information processing server 100. In FIG. 9, the information processing server 100 has a construction including a reception section 900, an object device information obtaining section 906, an object device determination section 907, an object device extraction section 908, an inquiry information editing section 909, an inquiry information transmission section 910, a timer section 911, a calculation section 912, a response information reception section 913, a response information editing section 914, a response information transmission section 915, a database creation section 916, an object device database 951, and a response information database 952. The reception section 900 includes an object device condition reception section 901, a timing information reception section 902, an inquiry information reception section 903, a time limit information reception section 904 and a numerical information reception section 905.

Of the reception section 900, the object device condition reception section 901 receives information relating to the condition of the information processing terminal unit 102 which is to be an object, the timing information reception section 902 receives timing information, the inquiry information reception section 903 receives inquiry information, the time limit information reception section 904 receives time limit information and the numerical information reception section 905 receives numerical information, respectively. The reception section 900 specifically realizes its function, for example, by the I/F 709 shown in FIG. 7. The content of each information which is received by each reception section 901 to 905 will be explained later.

The object device information obtaining section 906 obtains the information regarding in which area the information processing terminal unit 102, being an object, exists based on the inquiry information received by the inquiry information reception section 903. For example, the range of the position information obtained by the GPS or the zone range of a certain radio base station 104 is obtained as the object device information. The object device information obtaining section 906 realizes its function by the CPU 701 which executes programs stored in, for example, the ROM 702, the RAM 703, the HD 705 and the FD 707 shown in FIG. 7.

The object device determination section 907 narrows down the information processing terminal units 102 to be extracted from the relevant information processing terminal units 102 in the object device information obtained by the object device information obtaining section 906, based on the information relating to the condition of the information processing terminal unit 102, which is received by the object device condition reception section 901. That is, the object device information obtained by the object device information obtaining section 906, and the information relating to the information processing terminal unit 102 registered in the object device database 951 beforehand, for example, information relating to the person who carries the information processing terminal unit 102 are extracted, and the narrowed object device is determined by performing AND processing of the extracted information and the information relating to the above condition received by the object device condition reception section 901. The object device determination section 907 realizes its function by the CPU 701 which executes the program stored in, for example, the ROM 702, the RAM 703, the HD 705 and the FD 707 shown in FIG. 7.

The object device extraction section 908 extracts the object device determined by the object device determination section 907, based on the timing information received by the timing information reception section 902. That is, at the timing according to the timing information, the object device extraction section 908 gathers position information where each information processing terminal unit 102 exists, and compares the gathered position information with the information relating to the area obtained by the object device information obtaining section 906 to extract only an information processing terminal unit 102 which agrees therewith. The object device extraction section 908 realizes its function by the CPU 701 which executes the program stored in, for example, the ROM 702, the RAM 703, the HD 705 and the FD 707 shown in FIG. 7.

The inquiry information editing section 909 edits so that the respondent can easily respond to the inquiry information received by the inquiry information reception section 903. For example, when the inquiry content is the traffic jam information, choices are set by using the response master 115 shown in FIG. 6, so that the respondent can easily respond about the jammed state. The inquiry information editing section 909 realizes its function by the CPU 701 which executes the program stored in, for example, the ROM 702, the RAM 703, the HD 705 and the FD 707 shown in FIG. 7.

The inquiry information transmission section 910 transmits the inquiry information received by the inquiry information reception section 903 or the inquiry information edited by the inquiry information editing section 909 to the information processing terminal unit 102 extracted by the object device extraction section 908. The inquiry information transmission section 910 specifically realizes its function by for example the I/F 709 shown in FIG. 7.

The timer section 911 measures the time from the timing when the inquiry information transmission section 910 has transmitted the inquiry information based on the time limit information received by the time limit information reception section 904. The timing section 911 realizes its function by the CPU 701 which executes the program stored in, for example, the ROM 702, the RAM 703, the HD 705 and the FD 707 shown in FIG. 7.

The calculation section 912 counts the number of response information received by the response information reception section 913 described later. The calculation section 912 then judges if the number of the received response information has reached a predetermined number, based on the numerical information received by the numerical information reception section 905. The calculation section 912 realizes its function by the CPU 701 which executes the program stored in, for example, the ROM 702, the RAM 703, the HD 705 and the FD 707 shown in FIG. 7.

The response information reception section 913 receives the response information with respect to the inquiry information transmitted by the inquiry information transmission section 910 from each information processing terminal unit 102. The response information reception section 913 specifically realizes its function by for example the I/F 709 shown in FIG. 7.

The response information editing section 914 edits so that a person who inputs the inquiry information can easily recognize the response information received by the response information reception section 913. For example, the response information editing section 914 changes the received response information according to the number in the response master 115 shown in FIG. 6 (“1-1”), using the corresponding item of degrees (heavily jammed). At this time, the response information after the predetermined number has been reached by the calculation section 912 is not subjected to the editing processing. The response information editing section 914 realizes its function by the CPU 701 which executes the program stored in, for example, the ROM 702, the RAM 703, the HD 705 and the FD 707 shown in FIG. 7.

The response information transmission section 915 transmits the response information received by the response information reception section 913 or the response information edited by the response information editing section 914 to the information processing terminal unit 102, which has transmitted the inquiry. At this time, the response information after the predetermined number has been reached by the calculation section 912 is not subjected to the transmission processing. The response information transmission section 915 specifically realizes its function by, for example, the I/F 709 shown in FIG. 7.

The database creation section 916 registers the data relating to the response information in the response information database 952, being database associated with a predetermined area, based on the response information received by the response information reception section 913. At this time, the response information after the predetermined number has been reached by the calculation section 912 may not be subjected to the transmission processing. The database creation section 916 realizes its function by the CPU 701 which executes the program stored in, for example, the ROM 702, the RAM 703, the HD 705 and the FD 707 shown in FIG. 7.

Functional Configuration of the Information Processing Terminal unit:

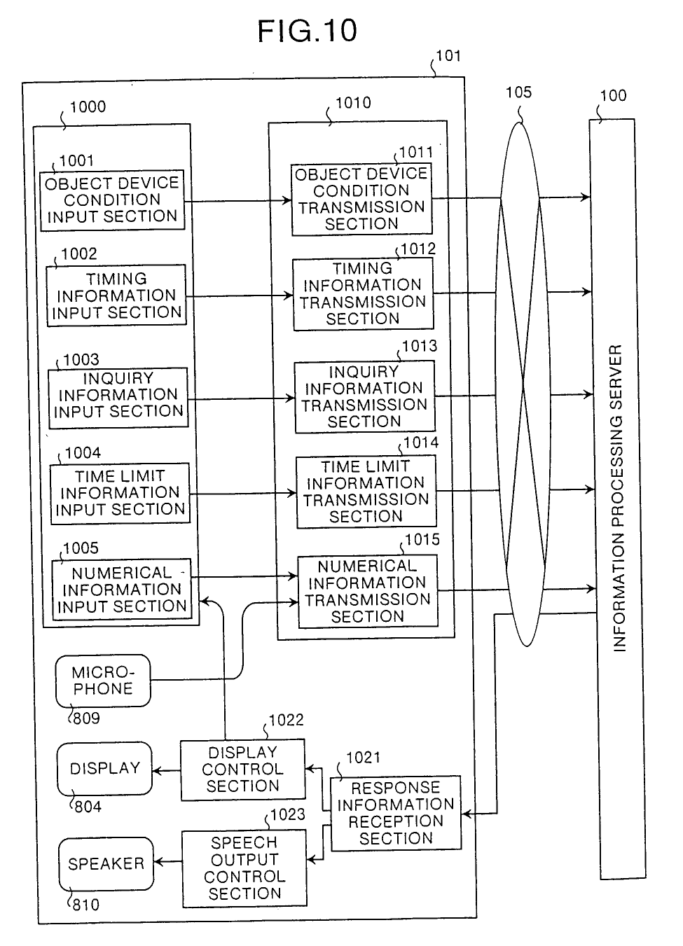

The functional configuration of the information processing terminal unit according to the embodiment of this invention will now be explained. FIG. 10 is a block diagram which shows the functional configuration of the information processing terminal unit 101. In FIG. 10, the information processing terminal unit 101 has a construction including an input section 1000, a transmission section 1010, a response information reception section 1021, a display control section 1022, and a speech output control section 1023, as well as the display 804, the microphone 809 and the speaker 810 shown in FIG. 8. The input section 1000 includes an object device condition input section 1001, a timing information input section 1002, an inquiry information input section 1003, a time limit information input section 1004, and a numerical information input section 1005. The transmission section 1010 includes an object device condition transmission section 1011, a timing information transmission section 1012, an inquiry information transmission section 1013, a time limit information transmission section 1014, and a numerical information transmission section 1015.

Of the input section 1000, the object device condition input section 1001 inputs information relating to the condition of the information processing terminal unit 102 which is to be an object, the timing information input section 1002 inputs timing information, the inquiry information input section 1003 inputs inquiry information, the time limit information input section 1004 inputs time limit information and the numerical information input section 1005 inputs numerical information, respectively. The input section 1000 specifically realizes its function, for example, by the ten key 807, the cursor instruction section 808 or the microphone 809 shown in FIG. 8.

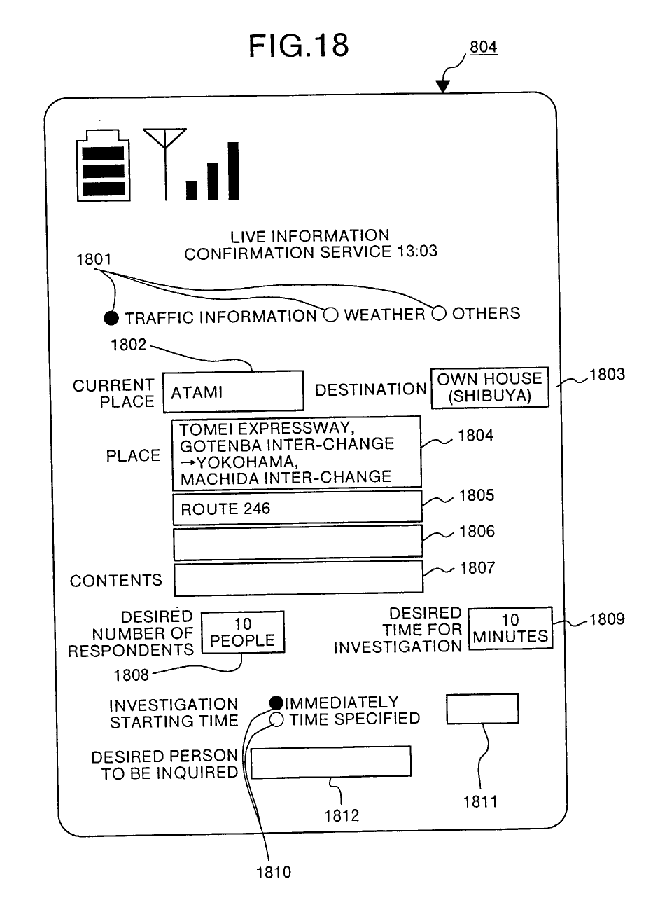

The information relating to the condition of the information processing terminal unit 102, which is to be an object, input by the object device condition input section 1001 corresponds to the information relating to the desired person to be inquired, which is input to a column 1808 for inputting desired person to be inquired in FIG. 18 described later. Specifically, the information includes information relating to person who carry the information processing terminal unit 102 (gender, age, occupation), and information relating to the reception situation of the past response information from each information processing terminal unit and the content of the received past response information.

Of the transmission section 1010, the object device condition transmission section 1011 inputs the information relating to the condition of the information processing terminal unit 102, which is to be an object, input by the object device condition input section 1001, the timing information transmission section 1012 inputs the timing information input by the timing information input section 1002, the inquiry information transmission section 1013 inputs inquiry information input by the inquiry information input section 1003, the time limit information transmission section 1014 inputs the time limit information input by the time limit information input section 1004, and the numerical information transmission section 1015 inputs the numerical information input by the numerical information input section 1005, respectively. The transmission section 1010 specifically realizes its function, for example, by the communication control section 806 shown in FIG. 8.

The response information reception section 1021 receives the response information with respect to the inquiry information transmitted by the inquiry information transmission section 1013, from the information processing server 100. The response information reception section 1021 specifically realizes its function, for example, by the communication control section 806 shown in FIG. 8.

The display control section 1022 displays the response information received by the response information reception section 102l on the display 804. The display control section 1022 realizes its function by the CPU 801 which executes the program stored in, for example, the ROM 802 and the RAM 803 shown in FIG. 8.

The speech output control section 1023 outputs the response information received by the response information reception section 1021 to the speaker 810. The speech output control section 1023 realizes its function by the CPU 801 which executes the program stored in, for example, the ROM 802 and the RAM 803 shown in FIG. 8.

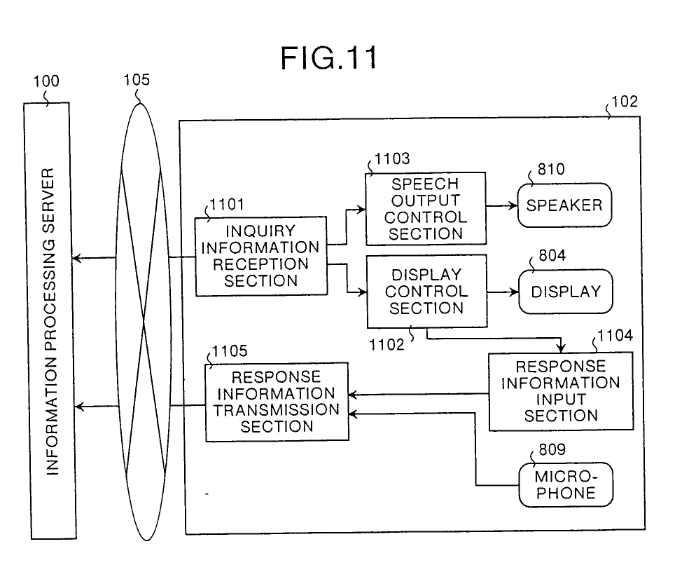

FIG. 11 is a block diagram which shows the functional configuration of the information processing terminal unit 102. In FIG. 11, the information processing terminal unit 102 has a construction including an inquiry information reception section 1101, a display control section 1102, a speech output control section 1103, a response information input section 1104 and a response information transmission section 1105, in addition to the display 804, the microphone 809 and the speaker 810 shown in FIG. 8.

The inquiry information reception section 1101 receives the inquiry information from the information processing server 100. The inquiry information reception section 1101 specifically realizes its function by for example the communication control section 806 or the like shown in FIG. 8.

The display control section 1102 displays the inquiry information received by the inquiry information reception section 1101 on the display 804. The display control section 1102 realizes its function by the CPU 801 which executes the program stored in, for example, the ROM 802 and the RAM 803 shown in FIG. 8.

The speech output control section 1103 outputs the inquiry information received by the inquiry information reception section 1101 to the speaker 810. The speech output control section 1103 realizes its function by the CPU 801 which executes the program stored in, for example, the ROM 802 and the RAM 803 shown in FIG. 8.

The response information input section 1104 inputs the response information with respect to the inquiry information displayed on the display 804 by the display control section 1102. The response information input section 1104 specifically realizes its function by, for example, the ten key 807, the cursor instruction section 808 or the microphone 809 shown in FIG. 8.

The response information transmission section 1105 transmits the response information input by the response information input section 1104 or the response information by speech input by the microphone 809 to the information processing server 100. Specifically, the response information transmission section 1105 realizes its function by for example the communication control section 806 shown in FIG. 8.

Processing Contents of the Information Processing Server:

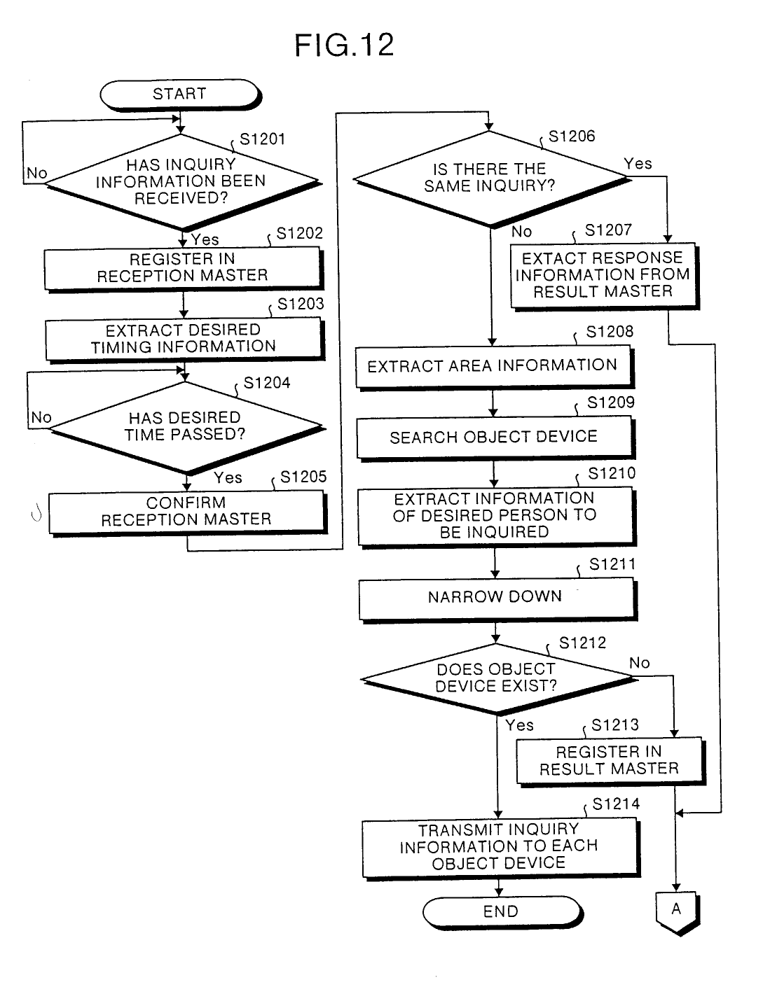

The processing contents of the information processing server 100 will be explained. FIG. 12 is a flowchart which shows a procedure for transmission processing of inquiry information by the information processing server 100 according to the embodiment of this invention. In the flowchart in FIG. 12, it is judged whether the inquiry information has been received from the information processing terminal unit 101 (step S1201). It is waited to receive the inquiry information and when the inquiry information is received, (step S1201, Yes), the received inquiry information is registered in the reception master 111 shown in FIG. 2 (step S1202).

As the information relating to the desired time, “desired timing information” registered in the reception master 111 is then extracted (step Sl2O3). Then, it is judged whether the desired time has passed (step S1204). That is, if “immediately” is registered in the “starting time for investigation ”, control immediately proceeds to step S1205. If the information relating to time is registered, after the time has passed, control proceeds to step S1205.

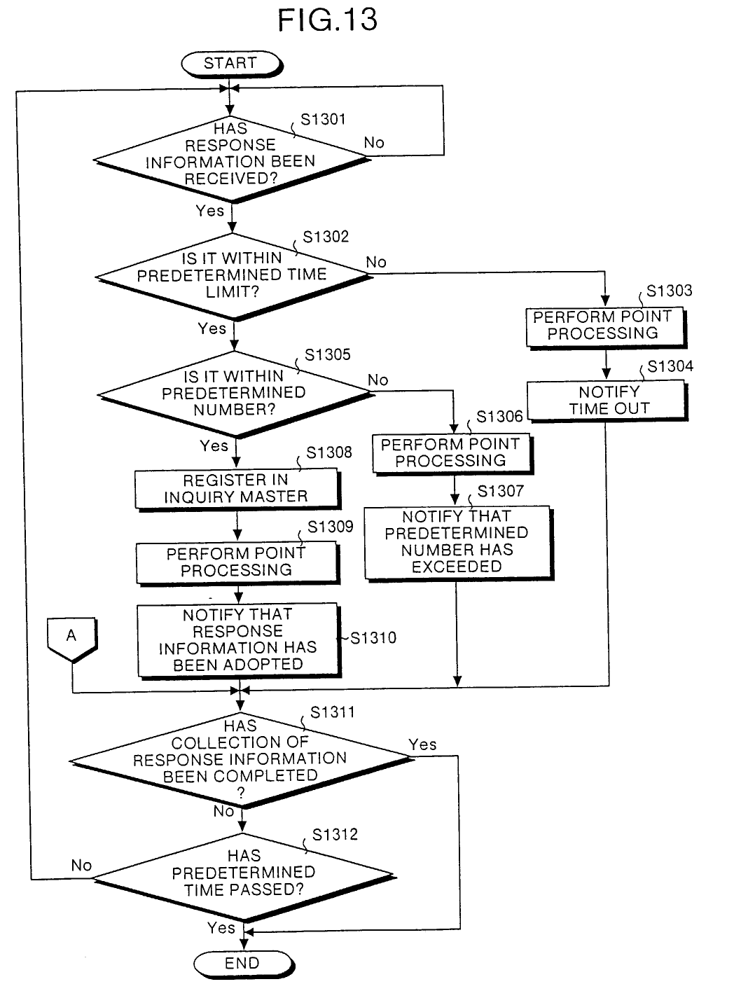

In step S1205, another inquiry information of the reception master 111 is confirmed. It is then judged whether an inquiry relating to the traffic jam information at the same spot is registered (step s1206). When the same inquiry is registered (step S1206, Yes), the “response” information with respect to the same inquiry is extracted from the result master 113 shown in FIG. 4 (step S1207). Thereafter, control proceeds to step S1311 shown in FIG. 13.

On the other hand, in step S1206, if the same inquiry is not registered (step S1206, No), the information relating to the area is extracted (step S1208), and an object device existing in the area is searched (step S1209). Then, the information relating to desired persons to be inquired is extracted (step S1210), to narrow down the object device based on the extracted condition (step S1211). If there is no information relating to the desired persons to be inquired, narrowing is not carried out. After narrowing has been carried out, it is judged whether an object device exists (step S1212). If there is no object device (step S1212, No), this matter is registered in the result master 113 shown in FIG. 4 (step S1213), and control proceeds to step S1311 shown in FIG. 13.

On the other hand, in step S1212, when more than one object devices exist (step S1212, Yes), the inquiry information is transmitted to each object device (step S1214), to thereby finish the transmission processing of the inquiry information. When there exist a plurality of object devices, the inquiry information may be transmitted by limiting the number of object devices in advance. The method of limiting the number of object devices in advance may be any method. For example, the extraction may be based on the transmission history of the past inquiry information, or a predetermined number may be extracted at random.

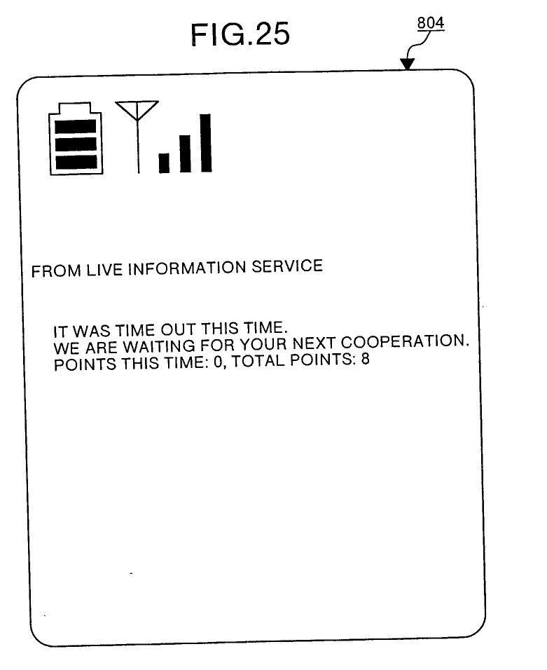

FIG. 13 is a flowchart which shows a procedure of reception processing of the response information of the information processing server 100 according to the embodiment of this invention. In FIG. 13, it is judged whether the response information with respect to the inquiry information transmitted in step S1214 in FIG. 12 has been received (step S1301). It is waited to receive the response information and when the response information is received, (step S1301, Yes), it is then judged whether the time when the response information has been received is within a predetermined time limit (step S1302). If the predetermined time limit has already passed (step S1302, No), processing for adding predetermined points as a reward for the response is carried out (step S1303), as required, invalidity is notified to the sender of the response information (step S1304), and thereafter, control proceeds to step S1311. Notification to the sender may be performed by a mail as shown in FIG. 25 described later, or by another method, for example, a predetermined kind of arrival sound may be made.

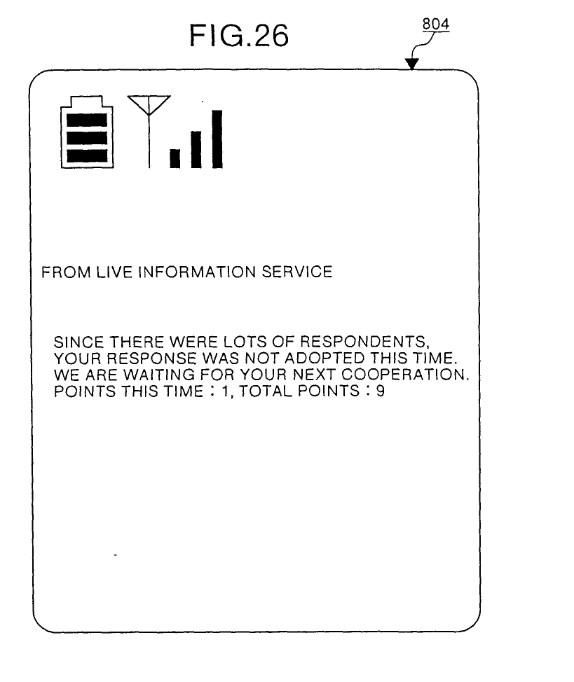

In step S1302, at the point of time when the response information has been received, if the predetermined time limit has not yet passed (step S1302, Yes), it is judged whether the received response information is within the predetermined number in the order of arrivals (step S1305). If the predetermined number is exceeded (step S1305, No), processing for adding predetermined points as a reward for the response is carried out (step S1306), as required, and it is notified to the sender of the response information that the predetermined number has been exceeded (step Sl3O7), and thereafter, control proceeds to step S1311. The notification to the sender may be carried out by a mail as shown in FIG. 26 described later, like the invalidity notification at step S1304, or by another method, for example, a predetermined kind of arrival sound may be made.

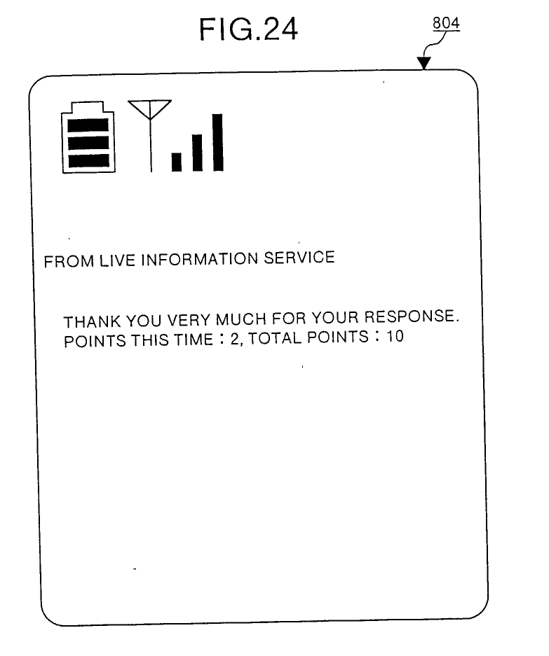

In step S1305, when the received response information is within the predetermined number in the order of arrivals (step S1305, Yes), the response information and the time responded are registered in the inquiry master 112 shown in FIG. 3 (step S1308). Thereafter, processing for adding predetermined points as a reward for the response is carried out (step S1309), and it is notified to the sender that the response information has been adopted (step S1310). The notification to the sender may be carried out by a mail as shown in FIG. 24 described later, like the invalidity notification at step S1304, or by another method, for example, a predetermined kind of arrival sound may be made.

It is then judged whether collection of response information has been completed, that is, response information has been received from all of the information processing terminal units 102 to which the inquiry information has been transmitted (step S1311). When collection has been completed (step S1311, Yes), the series of processing is finished. On the other hand, if collection has not been completed (step S1311, No), it is then judged if the predetermined time has passed without completing collection (step S1312). If the predetermined time has not yet passed (step S1312, No), control returns to step S1301, to repeat the series of processing from step S1301 to step S1312. On the other hand, in step S1312, if the predetermined time has passed (step S1312, Yes), the series of processing is finished.

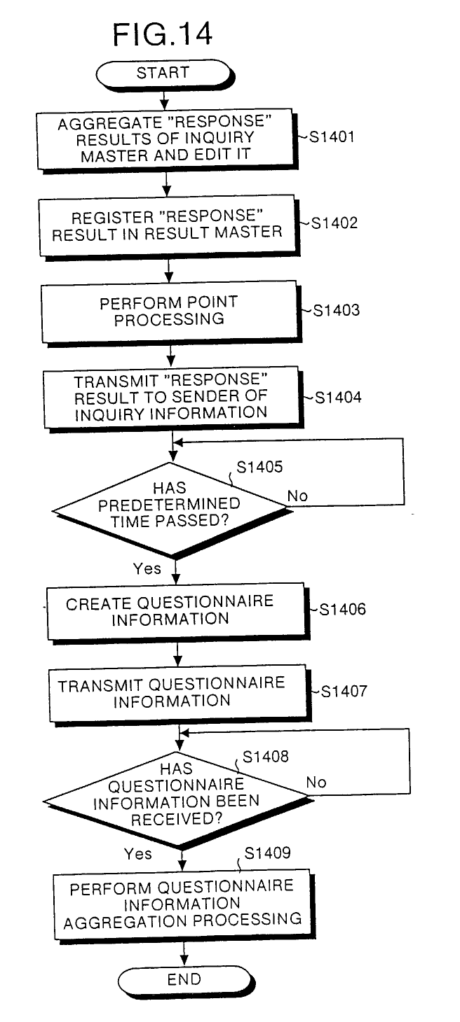

FIG. 14 is a flowchart which shows a procedure for transmission processing of the response information of the information processing server 100 according to the embodiment of this invention. In FIG. 14, the results of “responses” in the inquiry master 112 are aggregated and edited (step S1401), and the result thereof is registered in the result master 113 (step S1402).

When the response results are aggregated, the number of responses of YES, NO and responses by number are counted for each type of response, and the one having the larger number is designated to be right. When the content cannot be aggregated, the response contents are linked together. When there is only one response, this is designated to be right. If there is no response, it is made “not responded”.

Then, processing for subtracting predetermined points as compensation for response information rendered is carried out (step S1403). Thereafter, the result of “response” is transmitted to the information processing terminal unit 101, being the sender of the inquiry information (step S1404). As a result, processing relating to the information delivery is finished.

After the predetermined time has passed (step S1405, Yes), questionnaire information with respect to the response this time is prepared (step S1406), the prepared questionnaire information is transmitted to the information processing terminal unit 101, being the sender of the information (step S1407). Thereafter, It is waited to receive the questionnaire information and when the questionnaire information is received, (step S1408, Yes), aggregation of the received questionnaire information is carried out (step S1409), and thereby the series of processing is finished.

(Processing Contents of the Information Processing Terminal Unit)

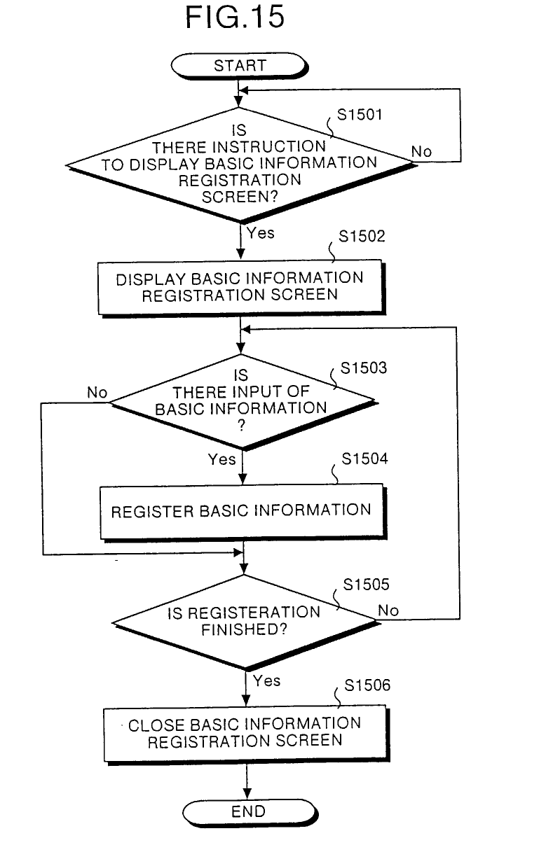

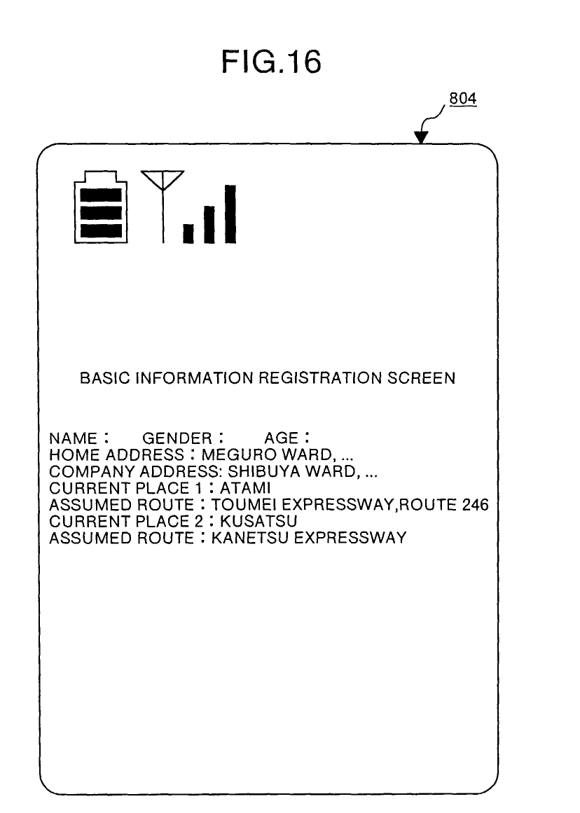

The processing contents of the information processing terminal unit 101 will now be explained. FIG. 15 is a flowchart which shows a processing procedure of the information processing terminal unit 101 according to the embodiment of this invention. In the flowchart of FIG. 15, it is first judged if there is a display instruction of a basic information registration screen (step S1501). If there is the display instruction (step S1501, Yes), the basic information registration screen as shown in FIG. 16 is displayed (step S1502).

It is then judged if there is an input of the basic information on the displayed basic information registration screen (step S1503). On the registration screen of the basic information, there can be registered beforehand the information relating to “name”, “home address”, “company address”, “destination 1”, “assumed route”, “destination 2”, “assumed route”, . . . If the basic information is not input (step S1503, No), control directly proceeds to step S1505. On the other hand, if the basic information is input (step S1503, Yes), the input basic information is registered (step S1504). It is waited to receive an instruction to finish the registration (step S1505), and if there is the instruction (step S1505, Yes), the basic information registration screen is closed (step S1506), to finish the processing.

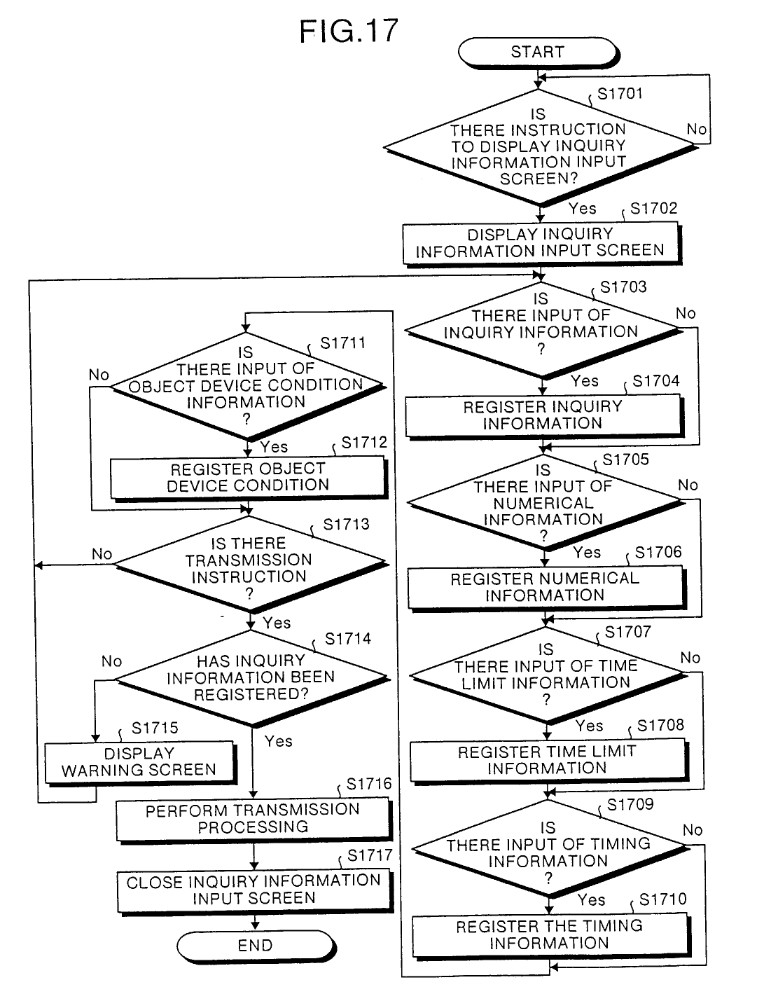

FIG. 17 is a flowchart which shows another processing procedure of the information processing terminal unit 101 according to the embodiment of this invention. In the flowchart of FIG. 17, it is first judged if there is a display instruction of an inquiry information input screen (step S1701). It is waited to receive the display instruction, and if there is the display instruction (step S1701, Yes), the inquiry information input (live information confirmation service) screen as shown in FIG. 18 is displayed (step S1702). It is then judged if there is an input of the inquiry information on the inquiry information input screen, that is, if information relating to place input columns 1804 to 1806 or a contents input column 1807 in FIG. 18 has been input (step S1703). If there is an input of inquiry information (step S1703, Yes), this inquiry information is registered (step S1704). If there is no input of inquiry information (step S1703, No), control directly proceeds to step S1705.

It is judged whether the numerical information has been input on the inquiry information input screen, that is, whether there is an input of information in a column 1808 for inputting desired number of respondents (step S1705). If the numerical information has been input (step S1705, Yes), the numerical information is registered (step S1706). If the numerical information has not been input (step S1705, No), control directly proceeds to step S1707.

It is judged whether the time limit information has been input on the inquiry information input screen, that is whether there is an input of information in a column 1809 for inputting the desired time for investigation (step Sl7O7). If the time limit information has been input (step S1707, Yes), the time limit information is registered (step S1708). If the time limit information has not been input (step S1707, No), control directly proceeds to step A1709.

It is judged whether the timing information has been input on the inquiry information input screen, that is, whether the investigation starting time has been selected or there is an input of information in a column 1809 for inputting the investigation starting time (step S1709). If the timing information has been input (step S1709, Yes), the timing information is registered (step S1710). If the timing information has not been input (step S1709, No), control directly proceeds to step S1711.

It is judged whether the object device condition information has been input on the inquiry information input screen, that is, whether there is an input of information in a column 1812 for inputting the desired person to be inquired (step S1711). If the object device condition information has been input (step S1711, Yes), the object device condition information is registered (step S1712). If the object device condition information has not been input (step S1711, No), control directly proceeds to step S1713.

It is then judged whether there is a transmission instruction (step S1713). The transmission instruction is given by, for example, pressing a predetermined ten key 807 or the like. If there is no transmission instruction (step S1713, No), control returns to step S1703, and thereafter, each processing of from step S1703 to step S1713 is repetitively carried out. That is to say, even if the information has been input once, the registered information can be changed by re-input, until the transmission instruction is given.

In step S1713, if there is a transmission instruction (step S1713, Yes), it is then judged if the inquiry information has been registered (step S1714). Information other than the inquiry information may not have been registered, but if the inquiry information has not been registered, the object device cannot be specified. If the inquiry information has not been registered (step S1714, No), a screen which warns this matter is displayed (step S1715), and control returns to step S1703.

On the other hand, in step S1714, when the inquiry information has been registered (step S1714, Yes), the inquiry information and the other information are transmitted to the information processing server 100 (step S1716). Thereafter, the inquiry information input screen is closed (step S1717), and the series of processing is finished.

FIG. 18 shows another example of display contents of the display 804 in the information processing terminal unit 101 according to the embodiment of this invention. In FIG. 18, the inquiry type is selected from each radio button 1801 of “traffic information”, “weather” and “others”. FIG. 18 shows that the “traffic information” has been selected. The information relating to this inquiry type is registered in the “inquiry category” of the reception master 111 shown in FIG. 2. In a column 1802 for inputting the current place (away from home), information relating to the current place is input. Alternatively, the information relating to the current place may be displayed by measuring the present position by the GPS function, without inputting the information relating to the current place by the person who carries the information processing terminal unit.

In a destination display column 1803, the area to which the person is going is input. If this information is registered in advance on the basic information registration screen shown in FIG. 16, candidates may be displayed in a list box format, so as to be able to choose therefrom. Reference numerals 1804, 1805 and 1806 indicate place input columns, so that a plurality of areas can be transmitted together. As a result, for example, when there are more than two routes, it can be easily understood which route is less jammed.

In FIG. 18, “Tomei Expressway, Gotenba→Yokohama, Machida” has been input in the place input column 1804, and route 246 has been input in the place input column 1805, either of which shows a route, which can be chosen, from the current place, that is, “Atami” towards the “own house (Shibuya)”. Alternatively, the route (main road) from the current place to the destination may be searched, and displayed in either one of the place input columns 1804 to 1806. If places where the person often goes and the routes used are registered in advance on the basic information registration screen, the route can be displayed in either one of the place input columns 1804 to 1806, only by specifying the place to go. The information relating to the place input columns 1804 to 1806 is registered in the “place” in the reception master 111 shown in FIG. 2.

When “others” is selected in the types of inquiry, specific inquiry content is input in the contents input column 1807. If “traffic information” or “weather” is selected in the types of inquiry, it is not necessary to input the specific inquiry contents in this contents input column 1807. The information relating to the contents input column 1807 is registered in the “inquiry” in the reception master 111 shown in FIG. 2. The information relating to the types of inquiry, the current place away from home, destination, place and contents is transmitted to the information processing server 100 as the inquiry information.

The desired number of respondents is input in the column 1808 for inputting desired number of respondents. The number of persons may be changed depending on the types of information. As the number increases, more accurate information can be collected, but the compensation for the information received increases. The information relating to the column 1808 for inputting the desired number of respondents is transmitted to the information processing server 100 as the numerical information, and in the information processing server 100, the number is registered in the “desired number of respondents” in the reception master 111 shown in FIG. 2.

Desired time for investigation (response time) is input in the column 1809 for inputting desired time for investigation. Thereby, the time for obtaining desired information can be set. The information relating to the column 1809 for inputting the desired time for investigation is transmitted to the information processing server 100 as the time limit information, and in the information processing server 100, the time limit information is registered in the “desired time for investigation” in the reception master 111 shown in FIG. 2.

The investigation starting time can be selected from “immediately” and “time specified” by the radio button 1810. The default should be set to “immediately”. When “time specified” is selected, the desired time is input in the column 1809 for inputting the desired time for investigation. For example, when it is desired to get the weather information for a predetermined area three hours later, only the request is made in advance, and the investigation information can be received three hours later. The information relating to the selection relating to the investigation starting time and the investigation starting time input column 1811 is transmitted to the information processing server 100 as the timing information, and in the information processing server 100, it is registered in the “investigation staring time” in the reception master 111 shown in FIG. 2.

In the column 1812 for inputting a desired person to be inquired, age, gender, a person who has a high response rate or a person who has never responded before can be input. The person who cannot believe the response may ask for another response. Due to the difference in expression or sensibility, it may be desired for him/her to ask people who is in the same gender or in the same age as he or she. As described above, investigation is possible based on the information relating to the person who carries the information processing terminal unit 102 (gender, age, occupation, etc.), and the information relating to the reception situation of the past response information from the information processing terminal unit 102 and the contents of response information received in the past. Thereby, the credibility of the obtained response can be further improved. The information relating to the column 1812 for inputting the desired person to be inquired is transmitted to the information processing server 100 as the object device condition, and in the information processing server 100, it is registered in the “desired person to be inquired” in the reception master 111 shown in FIG. 2.

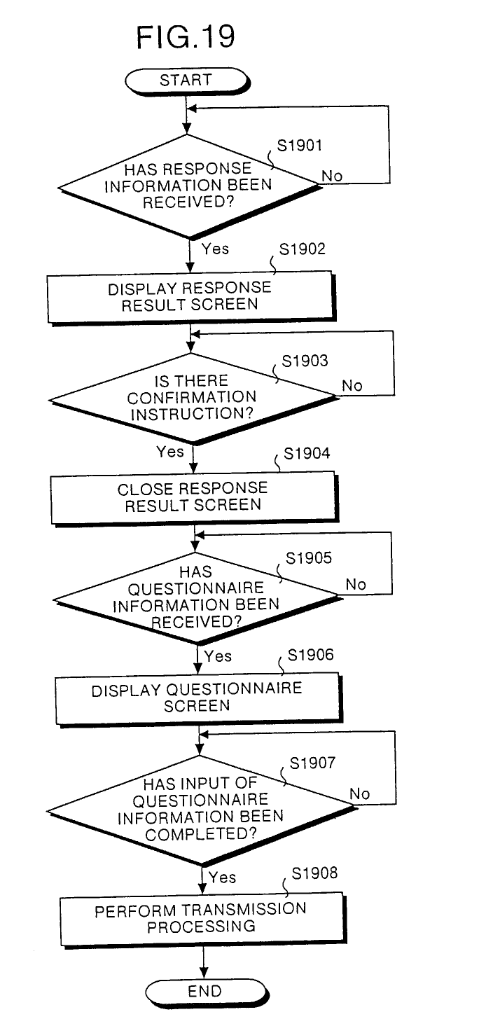

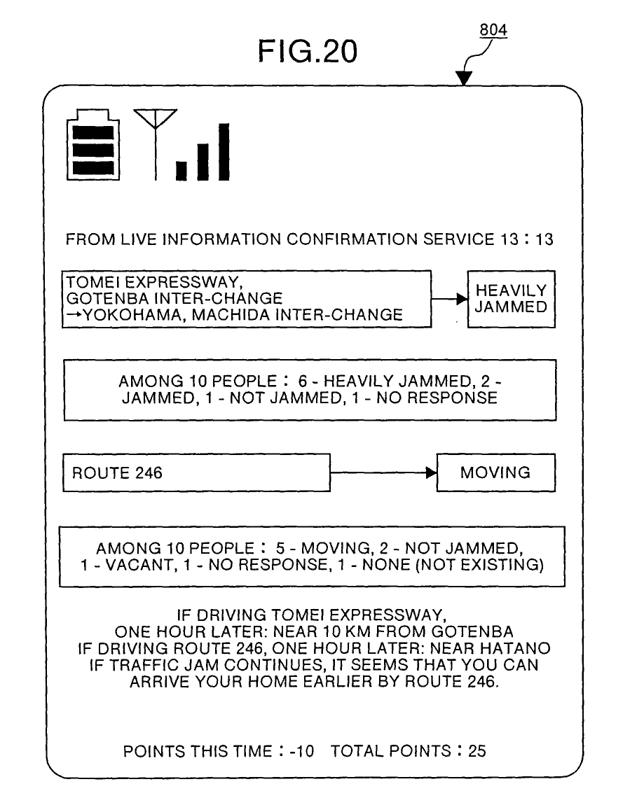

FIG. 19 is a flowchart which shows another processing procedure of the information processing terminal unit 101 according to the embodiment of this invention. In the flowchart in FIG. 19, it is first judged whether the response information transmitted from the information processing server 100 has been received (step S1901). It is waited to receive the response information, when it is received (step S1901, Yes), a response result screen as shown in FIG. 20 is displayed (step S1902).

It is then judged whether there is a confirmation instruction (step S1903). The confirmation instruction is given by, for example, pressing a predetermined ten key 807 or the like. It is waited for the confirmation instruction, and when there is the confirmation instruction (step S1903, Yes), the response result screen is closed (step S1904).

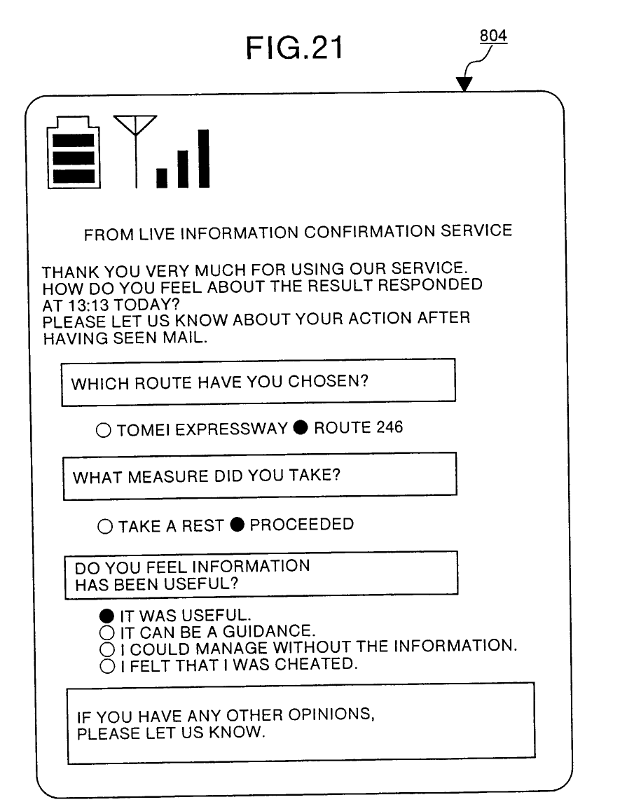

Thereafter, it is judged whether the questionnaire information transmitted from the information processing server 100 has been received (step S1905). It is waited to receive the questionnaire information, and when the questionnaire information is received (step S1905, Yes), the questionnaire screen as shown in FIG. 21 is displayed (step S1906). It is waited that an input of the questionnaire information on the questionnaire screen is completed, and it has been completed (step S1907, Yes), the questionnaire information is transmitted to the information processing server 100 (step S1908), and the series of processing is finished. The completion of the questionnaire is recognized by, for example, pressing a predetermined ten key 807 or the like.

FIG. 20 shows another example of display contents of the display 804 in the information processing terminal unit 101 according to the embodiment of this invention. In FIG. 20, the results and breakdown are notified (displayed). In the breakdown, “No response” indicates that the inquiry has been made, but there is no response obtained, and “None” indicates that there is nobody existing in that area. Therefore, in FIG. 20, it is indicated that the desired number of persons is 10, but there are only nine relevant persons.

It can be easily known by seeing the breakdown, how many people have told a lie or made an input error. It can be also known the response degree of those people. By displaying this breakdown, this can be used as a standard at the time of next inquiry. When there is traffic jam information, the vehicle speed is predicted from the degree of congestion in the response, and the time to the destination may be assumed from the distance and the above vehicle speed, and notified. If there is a road which the user does not know, and which may be less congested, this road may be also notified.

The cost required for this investigation is converted to points, and the points are subtracted (−10 points), and the total points (25 points) at present may be displayed. When the point is positive, those points may be applied to a call fee discount. On the other hand, when the point is negative, this may be added to the call fee and charged.

The fee may be collected in the same manner as the call fee. For example, the price may be set such that ¥10 for a user, ¥8 for a respondent, and ¥2 for the service provider, and the fee may be collected. At this time, when there is the same inquiry at the same instant, since inquiry is not necessary, the service provider can get ¥10 directly as the profit. Since it is assumed that a person may become a user of the service or a respondent, for example, the points can be calculated at the end of month, and paid off together with the telephone charges.

FIG. 21 shows another example of display contents of the display 804 in the information processing terminal unit 101 according to the embodiment of this invention. By displaying a questionnaire screen as shown in FIG. 21, and collecting the questionnaire, studies relating to whether the response information has been useful are carried out, and those studies may be used as reference data for the respondent ranking. The respondent ranking will be explained later.

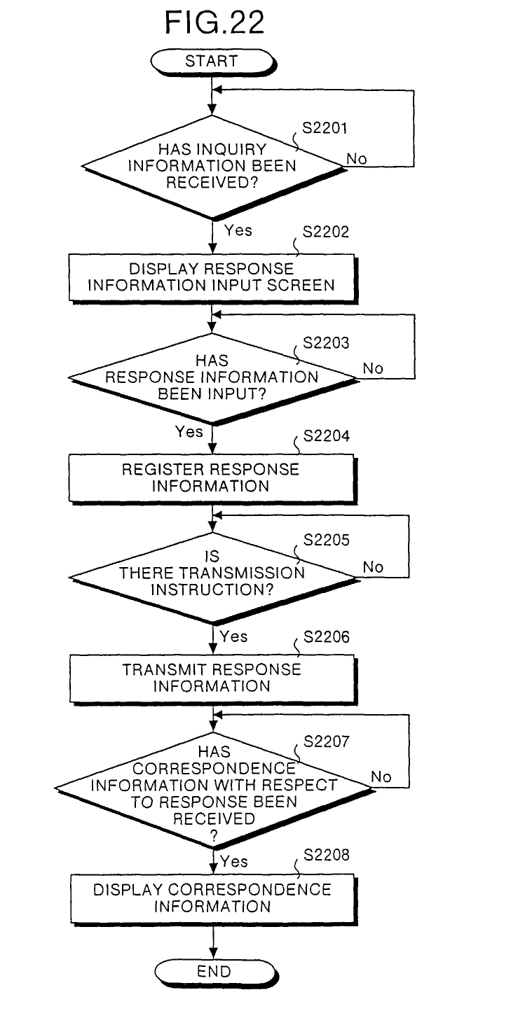

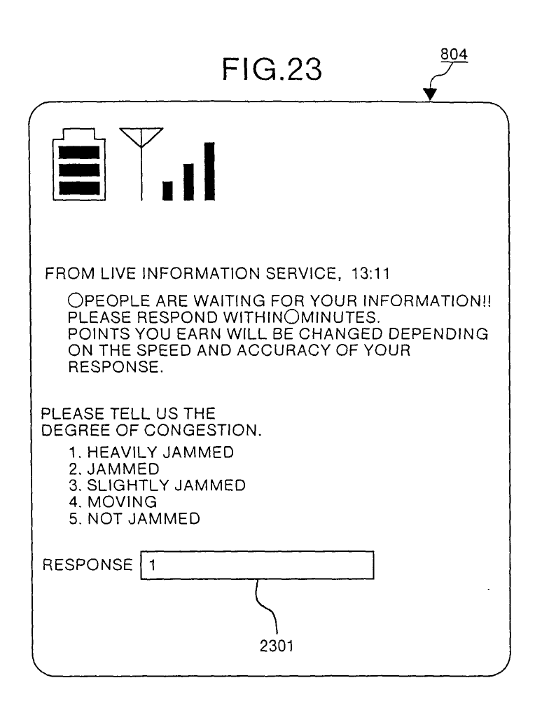

FIG. 22 is a flowchart which shows a processing procedure of the information processing terminal unit 102 according to the embodiment of this invention. In the flowchart in FIG. 12 [22], it is first judged if the inquiry information has been received (step S2201). It is waited to receive the inquiry information, and when the inquiry information has been received (step S2201, Yes), the response information input screen as shown in FIG. 23 is displayed (step S2202).

In FIG. 23, a plurality of choices relating to the degree are displayed so that responses can be made immediately and easily, and in a response column 2301, a number attached to each choice can be input from the ten key 807. By controlling the cursor by the cursor instruction section 808, either one of the choices may be selected.

It is judged whether the response information has been input on the response information input screen (step S2203). It is waited that the response information is input, and when the response information is input (step S2203, Yes), the response information is registered (step S2204).

It is then judged whether there is a transmission instruction of the response information (step S2205). The transmission instruction is given by, for example, pressing a predetermined ten key 807. It is waited to receive the transmission instruction, and when there is the transmission instruction, (step S2205, Yes), the response information is transmitted to the information processing server 100 (step S2206).

Thereafter, it is waited to receive correspondence information with respect to the response information transmitted from the information processing server 100, and when the correspondence information has been received (step S2207, Yes), the received correspondence information is displayed on the display 804 as shown in FIG. 24 and FIG. 25 (step S2208), to finish the series of processing.

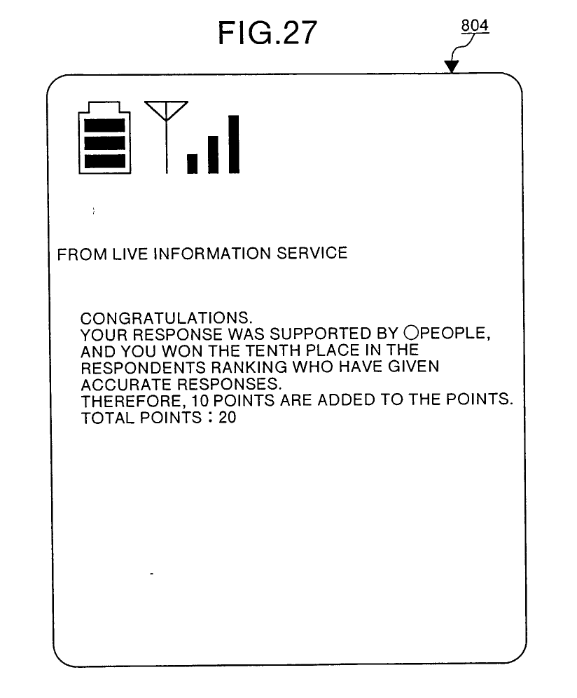

Special reward points may be given to the person who carries the information processing terminal unit 102, which has input and transmitted accurate response information, in addition to the reward for the response. FIG. 27 shows a notification mail notifying that the special reward points are given. In this manner, by providing a respondent ranking depending on the quickness and the accuracy of the response, motivation of the respondent can be improved, thereby the credibility of the response information can be improved.

As described above, according to this embodiment, since information desired to obtain, relating to a predetermined area, can be recognized as direct information from persons who are in this area on a real time basis, facts relating to the relevant area information can be reliably understood. Further, since a special facility which collects the information is not necessary, the information can be collected more easily.

By using the microphone 809 instead of the input section 1000 of the information processing terminal unit 101 or the response information input section 1104 of the information processing terminal unit 102, data input can be carried out by speech. By using the speaker 810 instead of the display 804 in the information processing terminal unit 101 or the display 804 in the information processing terminal unit 102, the data can be output by speech.

In the above-described embodiment, the inquiry information input by the information processing terminal unit 101 is used to respond to the input inquiry information to a person who carries the information processing terminal unit 102, but the present invention is not necessarily limited thereto. That is, the inquiry information may be registered in the information processing server 100 in advance, without having an input of the inquiry information, and this inquiry may be transmitted to the information processing terminal unit 102 at a predetermined timing, to thereby obtain the response information.

For example, by obtaining the traffic jam information for each location at a predetermined time interval, the traffic jam information can be obtained easily and accurately. This information may be stored in database, and provided to the third party, as an onerous or free news source, using homepage or other methods. As a result, highly accurate traffic jam information can be provided.

The number of responses and the desired investigation time (time limit information) input from the information processing terminal unit 101 are used, but the present invention is not limited thereto, and at least either one of the number of responses and the desired investigation time may be set by the information processing server 100.

The information gathering method and the information delivering method in this embodiment may be a computer readable program prepared in advance, wherein the methods are realized by executing the program by a computer such as a personal computer or a workstation. This program is recorded in a computer readable recording medium such as a HD (hard disk), a FD (flexible disk), a CD-ROM, a MO or a DVD, and read out from the recording medium by the computer and executed. This program may be a transmission medium that can be distributed via network such as the Internet.

As explained above, according to the present invention, by extracting the information processing terminal unit existing in a predetermined area and collecting desired information by directly accessing the extracted information processing terminal unit, unspecified majority carrying the information processing terminal unit can be the source of information. Therefore there is the effect that an information gathering method and an information delivering method, which can easily and reliably gather and provide area information having immediacy, an information processing program, a computer readable recording medium, an information processing server and an information processing terminal unit can be obtained.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information gathering method comprising:
an object device extraction step of extracting all or a part of information processing terminal units which are present in a predetermined area;
an inquiry information transmission step of transmitting inquiry information relating to the predetermined area to the extracted information processing terminal unit(s);
a response information reception step of receiving response information obtained in response to the transmitted inquiry information from the extracted information processing terminal units; and
a database creation step of creating a database of the response information corresponding to the predetermined area.

2. The information gathering method according to claim 1, further comprising an object device determination step of determining the information processing terminal unit to which the inquiry information is transmitted, based on at least either one of the information relating to the person who carries the information processing terminal unit, the reception situation of the past response information from each information processing terminal unit, and the content of the received past response information, from the information processing terminal units extracted by the object device extraction step,
wherein the inquiry information is transmitted to the information processing terminal unit determined at the object device determination step.

3. The information gathering method according to claim 1, wherein in the database is created based on the received response information within predetermined time from the point of time when the inquiry information has been transmitted.

4. The information gathering method according to claim 1, wherein the database is created based on a predetermined number of the response information in the order of reception of the response information.

5. An information delivering method comprising:
an inquiry information reception step of receiving inquiry information relating to a predetermined area;
an object device extraction step of extracting all or a part of information processing terminal units which are present in the predetermined area;
an inquiry information transmission step of transmitting inquiry information to the extracted information processing terminal units;
a response information reception step of receiving response information obtained in response to the transmitted inquiry information from the extracted information processing terminal units; and
a response information transmission step of transmitting the received response information as it is or edit information obtained by editing the response information to the sender of the inquiry information.

6. The information delivering method according to claim 5, further comprising an object device determination step of determining the information processing terminal unit to which the inquiry information is transmitted, based on at least either one of the information relating to the person who carries the information processing terminal unit, the reception situation of the past response information from each information processing terminal unit, and the content of the received past response information, from the information processing terminal units extracted by the object device extraction step,
wherein the inquiry information is transmitted to the information processing terminal unit determined at the object device determination step.

7. The information delivering method according to claim 5, wherein at the response information transmission step, any one of
the response information received at the response information reception step within a predetermined time from the point of time when the inquiry information has been transmitted at the inquiry information transmission step, and
the edit information obtained by editing the response information
is transmitted to the sender of the inquiry information.

8. The information delivering method according to claim 7, wherein at the inquiry information reception step, information relating to the predetermined time is received.

9. The information delivering method according to claim 5, wherein at the response information transmission step, a predetermined number of the response information or the edit information is transmitted to the sender of the inquiry information in the order of reception, of the response information received at the response information reception step.

10. The information delivering method according to claim 9, wherein in the inquiry information reception step, the information relating to the predetermined number is received.

11. The information delivering method according to claim 5, wherein at the inquiry information reception step, the information relating to the timing when the response information with respect to the inquiry information is obtained is received, and
at the object device extraction step, the information processing terminal units present in the predetermined area are extracted based on the information relating to the timing received at the inquiry information reception step.

12. An information processing computer program containing instructions which when executed on a computer causes the computer to perform:
an object device extraction step of extracting all or a part of information processing terminal units which are present in a predetermined area;
an inquiry information transmission step of transmitting inquiry information relating to the predetermined area to the extracted information processing terminal unit(s);
a response information reception step of receiving response information obtained in response to the transmitted inquiry information from the extracted information processing terminal units; and
a database creation step of creating a database of the response information corresponding to the predetermined area.

13. The information processing program according to claim 12, further containing instructions which when executed on the computer causes the computer to perform an object device determination step of determining the information processing terminal unit to which the inquiry information is transmitted, based on at least either one of the information relating to the person who carries the information processing terminal unit, the reception situation of the past response information from each information processing terminal unit, and the content of the received past response information, from the information processing terminal units extracted by the object device extraction step,
wherein the inquiry information is transmitted to the information processing terminal unit determined at the object device determination step.

14. An information processing computer program containing instructions which when executed on a computer causes the computer to perform:
an inquiry information reception step of receiving inquiry information relating to a predetermined area;
an object device extraction step of extracting all or a part of information processing terminal units which are present in the predetermined area;
an inquiry information transmission step of transmitting inquiry information to the extracted information processing terminal units;
a response information reception step of receiving response information obtained in response to the transmitted inquiry information from the extracted information processing terminal units; and
a response information transmission step of transmitting the received response information as it is or edit information obtained by editing the response information to the sender of the inquiry information.

15. The information processing program according to claim 14, further containing instructions which when executed on the computer causes the computer to perform an object device determination step of determining the information processing terminal unit to which the inquiry information is transmitted, based on at least either one of the information relating to the person who carries the information processing terminal unit, the reception situation of the past response information from each information processing terminal unit, and the content of the received past response information, from the information processing terminal units extracted by the object device extraction step,
wherein the inquiry information is transmitted to the information processing terminal unit determined at the object device determination step.

16. The information processing program according to claim 14, wherein at the response information transmission step, any one of
the response information received at the response information reception step within a predetermined time from the point of time when the inquiry information has been transmitted at the inquiry information transmission step, and
the edit information obtained by editing the response information
is transmitted to the sender of the inquiry information.

17. The information processing program according to claim 14, wherein at the response information transmission step, a predetermined number of the response information or the edit information is transmitted to the sender of the inquiry information in the order of reception, of the response information received at the response information reception step.

18. The information processing program according to claim 14, wherein at the inquiry information reception step, the information relating to the timing when the response information with respect to the inquiry information is obtained is received, and
at the object device extraction step, the information processing terminal units present in the predetermined area are extracted based on the information relating to the timing received at the inquiry information reception step.

19. A computer readable recording medium for storing instructions, which when executed on a computer, causes the computer to perform:
an object device extraction step of extracting all or a part of information processing terminal units which are present in a predetermined area;
an inquiry information transmission step of transmitting inquiry information relating to the predetermined area to the extracted information processing terminal unit(s);
a response information reception step of receiving response information obtained in response to the transmitted inquiry information from the extracted information processing terminal units; and
a database creation step of creating a database of the response information corresponding to the predetermined area.

20. A computer readable recording medium for storing instructions, which when executed on a computer, causes the computer to perform:
an inquiry information reception step of receiving inquiry information relating to a predetermined area;
an object device extraction step of extracting all or a part of information processing terminal units which are present in the predetermined area;
an inquiry information transmission step of transmitting inquiry information to the extracted information processing terminal units;
a response information reception step of receiving response information obtained in response to the transmitted inquiry information from the extracted information processing terminal units; and
a response information transmission step of transmitting the received response information as it is or edit information obtained by editing the response information to the sender of the inquiry information.

21. An information processing server comprising:
an object device extraction unit which extracts all or a part of information processing terminal units which are present in a predetermined area;
an inquiry information transmission unit which transmits inquiry information relating to the predetermined area to the extracted information processing terminal unit(s);
a response information reception unit which receives response information obtained in response to the transmitted inquiry information from the extracted information processing terminal units; and
a database creation unit which creates a database of the response information corresponding to the predetermined area.

22. An information processing server comprising:
an inquiry information reception unit which receives inquiry information relating to a predetermined area;
an object device extraction unit which extracts all or a part of information processing terminal units which are present in the predetermined area;
an inquiry information transmission unit which transmits inquiry information to the extracted information processing terminal units;
a response information reception unit which receives response information obtained in response to the transmitted inquiry information from the extracted information processing terminal units; and
a response information transmission unit which transmits the received response information as it is or edit information obtained by editing the response information to the sender of the inquiry information.

23. An information processing terminal unit comprising:
an inquiry information reception unit which receives inquiry information relating to a predetermined area from an information processing server;
an inquiry information output unit which outputs the received inquiry information;
a response information input unit inputting response information corresponding to the received inquiry information; and
a response information transmission unit which transmits the response information to the information processing server.

24. An information processing terminal unit comprising:
an inquiry information input unit for inputting inquiry information relating to a predetermined area;
an inquiry information transmission unit which transmits the input inquiry information to an information processing server;
a response information reception unit which receives response information corresponding to the transmitted inquiry information; and
a response information output unit which outputs the received response information.

25. The information processing terminal unit according to claim 24, further comprising a timing information input unit for inputting information relating to timing at which the response information is obtained, and
the inquiry information transmission unit transmits the information relating to the timing together with the inquiry information.
